(19) United States
(12) Patent Application Publication
(10) Pub. No.: US 2004/0203630 A1
(43) Pub. Date: Oct. 14, 2004

(54) Method and apparatus for targeting service delivery to mobile devices

(76) Inventor: Charles Chuanming Wang, Jamison, PA (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/099,635

(22) Filed: Mar. 15, 2002

(51) Int. Cl. H04M 3/00

(52) U.S. Cl. 455/414.1; 455/419

(57) ABSTRACT

Apparatus and method for providing personalized information from a service provider to a plurality of users using mobile terminals. Specifically, at least one content server stores content in at least one content database. Additionally, at least one subscriber database stores personalized user profiles. A plurality of base stations respectively provide wireless communications coverage over a plurality of cells between the at least one server of the service provider and the mobile terminals. Upon receiving a user request for content, the content server searches for the requested content based upon the spatial, temporal, and user preference information stored in the subscriber and content databases. Once the requested content is retrieved, the content server provides search results to the mobile terminal.

### BACKGROUND OF THE INVENTION

1. Field of Invention

The present invention relates to the field of mobile communications, and more particularly to the provisioning of data and information to users of mobile information appliances and communication devices.

2. Description of the Background Art

Personalization of commerce or targeted advertising has become popular with fixed (i.e., stationary) terminals, such as cable television set-top boxes, television sets, desktop computers, and the like. In particular, a service provider selects the most relevant and effective advertisements for transmission to the fixed terminals based on general demographic profiles of a region, or specific demographic profiles of an individual or household.

In a mobile wireless environment, mobile terminals (e.g., cellular phones, laptop computers, personal digital assistants (PDA's), and the like) may connect to wireless networks at any time and anywhere over a very large wireless service area. As a tradeoff for the convenience of mobility, demographic profile information plays much less of an important role for a mobile terminal user, since region-specific demographic assumptions may no longer be valid for a user.

Services for mobile terminals based on location only parameters have been proposed, for example, displaying a STARBUCKS® logo on a mobile terminal's display device when a user passes by a STARBUCKS® coffee store. This type of service relies only on location information, and is therefore extremely limited in capability to provide personalized and more precise types of selective services to users.

### SUMMARY OF INVENTION

The disadvantages heretofore associated with the prior art, are overcome by the present invention of an apparatus and method for providing personalized information to a plurality of mobile terminals. Specifically, one or more servers store various content in at least one content database. Additionally, at least one subscriber database stores personalized user profiles. A plurality of base stations respectively provide wireless communications coverage over a plurality of cells between the at least one server of the service provider and the mobile terminals.

Upon receiving a user request for content, a content server provides the content, based upon location, time, and personal profile information of the user. Specifically, the content server identifies spatial, temporal, and personal profile information corresponding to a user request for content. The content server then searches for the requested content based upon the spatial, temporal, and user preference information stored in the subscriber and content databases. Once the requested content is retrieved, the server provides search results to the mobile terminal.

### BRIEF DESCRIPTION OF THE DRAWINGS

The teachings of the present invention can be readily understood by considering the following detailed description in conjunction with the accompanying drawings, in which:

FIG. 1 depicts a block diagram of a wireless communications system over which an exemplary embodiment of the present invention is utilized;

FIG. 2 depicts a block diagram illustrating communication paths between an exemplary server and various components of the wireless communications system of FIG. 1 and in accordance with the principles of the present invention; and

FIG. 3 depicts a data flow diagram between various components of the wireless communications system of FIG. 1, in accordance with the principles of the present invention.

To facilitate understanding of the invention, identical reference numerals have been used, where possible, to designate identical elements that are common to the figures.

### DETAILED DESCRIPTION OF THE INVENTION

The present invention allows a user to access a service provider from any covered location using a mobile device, and subsequently receive personalized information based on the user's location, time of day, and the user's personal profile (e.g., preferences or interests). It will be appreciated by those skilled in the art that third party service providers may provide services to users, that competing or cooperating wireless or wired networks may be employed to facilitate user (i.e., subscriber) requests, and that requests may be made for information or content directly, or for descriptive information regarding content.

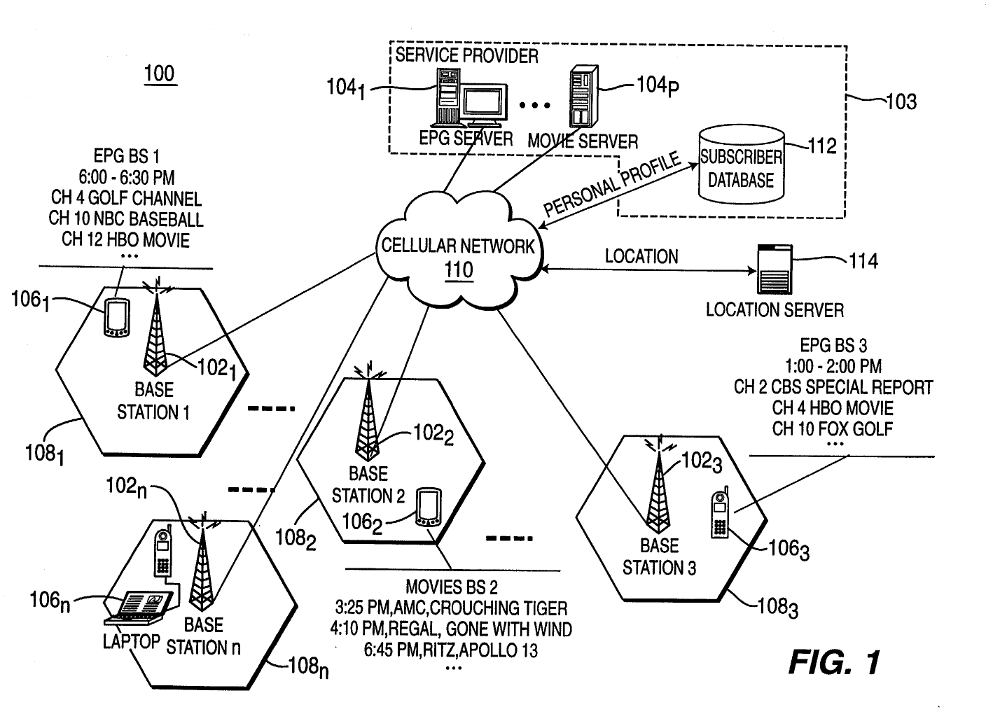

FIG. 1 depicts a block diagram of a wireless communications system 100 adapted according to the present invention. The wireless communications system 100 includes a cellular network 110, a service provider 103 and a plurality of mobile terminals 106, which are typically used by subscribers of the service provider 103, which has an arrangement to use the cellular network 110 from, for example, a wireless mobile telephone carrier. Alternatively, the users may be subscribers of both the service provider 103 and the carrier of the cellular network 110. The cellular network 110 is formed in part by a plurality of geographic regions or cells 108₁ through 108ₙ (collectively, geographic regions 108) having respective base stations 102₁ through 102ₙ (collectively, base stations 102). The cellular network 110 is owned by, for example, a wireless telecommunications carrier such as AT&T, SPRINTPCS and the like. The service provider 103 and mobile terminals 106 communicate in the geographic regions 108 through the cellular network 110. Multiple cellular networks may serve the same or similar geographic regions.

In one embodiment, a location server 114, such as a gateway mobile location center (hereinafter “GMLC”), is a part of the cellular network 110. Alternatively, the mobile terminals 106 may include Global Positioning System (GPS) capabilities to provide location information to the service provider 103. Other cellular network nodes, such as a base station controller and core network (not shown) are extraneous to this invention, and therefore are aggregately incorporated within the cellular network 110 of FIG. 1.

Each base station 102 provides wireless (e.g., cellular) communication coverage for a specific geographic region or cell 108. For example, the service provider may have coverage across most major cities (e.g., Los Angeles Calif., Boston Mass., and the like) or across other areas of the country. In the embodiment of FIG. 1, first base station 102₁ provides wireless communications for that cell 108₁, base station 102₂ provides wireless communications for the second cell 108₂, and so forth.

A plurality of mobile terminals 106₁ through 106ₙ (collectively, mobile terminals 106) each communicate with a service provider 103 through the base stations 102 of their geographic regions 108. The service provider 103 is capable of providing Location Communication Services (LCS) via the cellular network 110.

The service provider 103 may be a part of the cellular network 110, but more likely is a separate entity from the cellular network 110. The service provider 103 comprises one or more centralized content servers 104 and a subscriber database 112. The content servers 104 provide various types of information to users via the mobile terminals 106. In one embodiment, a centralized server or a group of servers 104 may be used to provide information to all of the base stations 102 in their respective geographic locations 108. Alternately, a plurality of servers 104 may be distributed throughout the geographic locations 108 in any configuration capable of transferring localized information to each base station 102, and ultimately, to the users. For example, each cell 108 may have a respective information server 104, or one or more servers 104 may be shared between two or more cells.

In one embodiment, a centralized subscriber database 112 stores personal and preferential (i.e., profile) information of the users of the service provider 103, such as preferences, income, habits, and the like. The personalized data may include preferential information regarding various topics and subject matter, such as types of entertainment, travel and hotel accommodations, restaurants, shopping, and/or any other subject matter. For example, a particular user may have a middle-income standard of living, and have preferences for Italian restaurants, romantic movies, racecars, and art museums. Each user may provide such personalized information to the cellular service provider 103 and update the personalized data as required.

The subscriber database 112 is optionally programmed to automatically “learn” from the user's requests by monitoring user patterns, habits, and the like. Specifically, in one embodiment, the subscriber database 112 tracks and categorizes the user requests and selections for information to formulate personalized information, which is subsequently categorized into various user preferences by the server 104. Such collected information is stored in the centralized subscriber database 112 as depicted in the embodiment of FIG. 1.

In another embodiment, the database 112 is a database distributed across the cells 108. That is, some or all of the cells 108 have a respective distributed database 112. In either of the embodiments, the distributed databases 112 are networked together to ultimately form a composite database 112.

The location of the mobile terminal 106 is required for the service provider 103 to provide personalized information based on the user's location, time of day, and the user's personal profile. In an embodiment where a location server 114 is used, the location server 114 stores the location information of the user when the user activates their mobile terminal 106, when the mobile terminal 106 performs a system check function, or when the user travels with the mobile terminal 106.

The content server 104 of the service provider 103 can communicate with the location server 114 through a standardized interface to request the location information of a user. With respect to determining the location of a mobile terminal 106 within a cell 108, several techniques are known. For example, three cell towers may be used to determine location using triangulation techniques, such as Time of Arrival (TOA) positioning or Time Difference of Arrival (TDOA) positioning. In this case, multiple towers communicate with each other to exchange information pertaining to mobile terminals that they have detected. A person skilled in the art will recognize that other positioning techniques with varying degrees of accuracy (ranging from a few meters to an entire cell 108) may be utilized to locate a mobile terminal 106.

As discussed above, in one embodiment, the mobile terminals 106 communicate with the location server 114 to provide the location of the mobile terminals 106 to the content server 104. In another embodiment, the mobile terminals 106 have location tracking (e.g., GPS) capabilities (not shown) installed. The location tracking capabilities allow the mobile terminals 106 to communicate their location directly to the service provider 103. As such, the location server 114 of the cellular network 110 is not required in this second embodiment. Rather, the location tracking equipment interfacing with a mobile terminal 106 may be provided by either the service provider 103, or by a third party location tracking service.

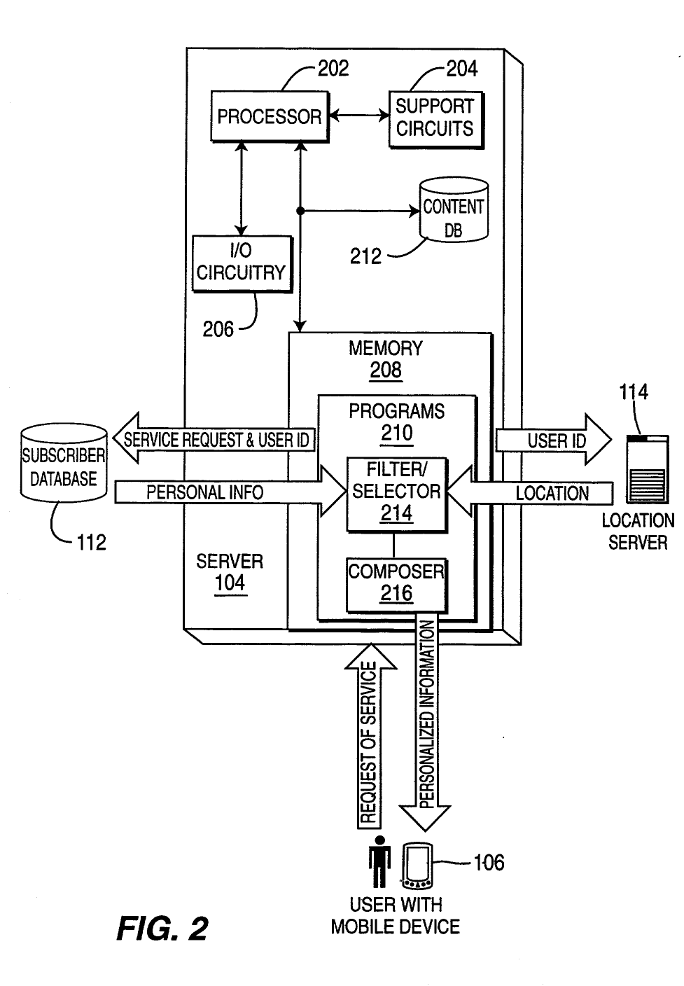

FIG. 2 depicts a block diagram illustrating communication paths between an exemplary information server 104 and various components of the wireless communications system of FIG. 1. Specifically, the exemplary content server 104 of FIG. 2 comprises a processor 202, as well as memory 208 for storing various programs 210, such as a filter/selector program 214 and a composer program 216, as discussed below. The processor 202 cooperates with conventional support circuitry 204, such as power supplies, clock circuits, cache memory, and the like, as well as circuits that assist in executing a software routine stored in the memory 208. As such, it is contemplated that some of the process steps discussed herein as software processes may be implemented within hardware, for example, as circuitry that cooperates with the processor 230 to perform various steps. The server 104 also contains input/output (I/O) circuitry 206 that forms an interface between the various functional elements communicating with the server 104, such as the cellular network 110, the subscriber database 112, and the location server 114.

The content servers 104 also include various content databases 212, which typically include entertainment information, such as electronic program guide (EPG) information, movie listings, restaurants, parks, museums, and the like. However, other content databases may also include travel information, shopping information, or any other subject matter of interest. Where the service provider 103 has a centralized server or group of servers 104, the information in each category is further categorized by the geographic location (e.g., cell) 108, type, style, and/or any other relevant category, as required. In particular, a filter program 214 categorizes the content stored on the various content databases 212.

For example, a museum database will include those museums located within a particular geographic location 108, the type of museum (e.g., art, technology related, transportation, and the like), relevant temporal information (e.g., the days and hours open), and so forth. Similarly, where the service provider 103 comprises a plurality of servers 104 that are distributed across the cells 108, then those servers 104 need only include specific information relevant to the cells 108 where the server (or servers) 104 resides. Optionally, the servers may store additional information to back each other up.

The composer application program 216 converts the requested content from the content database 212 into a format suitable for the requesting subscriber terminal 106. For example, the composer 216 may convert ordinary text from the content database 212 into hypertext markup language (HTML) formatted information suitable for a mobile terminal 106 having web-browsing capabilities.

The mobile terminals 106 are used to receive content from the service provider 103 based on spatial, temporal, and personal profile related information. The mobile terminals 106 may be any mobile device capable of transmitting and receiving wireless communication signals, such as a cellular phone, laptop computer, personal digital assistant (PDA), and the like. In one embodiment, the mobile terminals 106 may provide a user with only text messaging capabilities. In more sophisticated embodiments, the mobile terminals 106 may provide a user with web-browsing capabilities, thereby enabling reception of, for example, HTML formatted information. In this latter embodiment, the mobile terminals 106 include a browser, which is capable of decoding and displaying HTML documents. Optionally, the mobile terminals 106 have location tracking capabilities, as discussed above.

A user (e.g., subscriber) of a mobile terminal 106 may communicate with the service provider 103 once the user is within the geographic location 108 of a particular base station 102. That is, within the transmitting and receiving range of the cell 108. For example, any subscriber using their cellular phones, PDA's, or laptops within the second cell 1082 will have wireless coverage through base station 2 102₂. If, for example, a user relocates within the third cell 108₃, such user will have wireless coverage through base station 3 102₃. Optionally, a cooperating or competing network may provide access to the service provider 103 during, for example, a “roaming” communication from the mobile terminal 106. Optionally the cooperating or competing network provides location data as well as time data to the service provider 103.

The mobile terminals 106 may also include additional hardware and application software to perform specialized tasks or functions. For example, in one embodiment, the mobile terminal 106 includes a built-in universal remote controller function. A personal digital assistant (PDA) function may also be included. A user first requests a personalized EPG service from his terminal. The user may highlight a TV program shown on the display screen of the mobile terminal 106 and select the desired channel by, illustratively, implementing a JAVA applet embedded with the HTML. Further, by using channel-up/down or numerical buttons, the user may also directly select viewing channels from the mobile terminal 106. A person skilled in the art will recognize that other multimedia tools, such as MPEG-4, ATVEF, DASE, SHOCKWAVE, FLASH, and the like, may also be used as interactive user interfaces on mobile terminals having sufficient memory and software capabilities (e.g., laptop) 106.

The mobile terminals 106 operate in conjunction with the content servers 104 of the service provider 103, as well as the location server 114 of the cellular network 110 to update the user's spatial, temporal, and personal profile information. Typically, the location server 114 is operated by the cellular network 110 or a third party positioning service coupled to the cellular network 110. In particular, the cellular network 110 or positioning service monitors the location of each user and stores such location information in the location server 114. The location of each user is updated each time the user activates the mobile terminal 106, including during travel. Additionally, temporal information is also updated through the synchronization of the clocks of the base stations 102 and the mobile terminals 106. Spatial and/or temporal information may be updated continuously or periodically according to the cellular network 110 configuration.

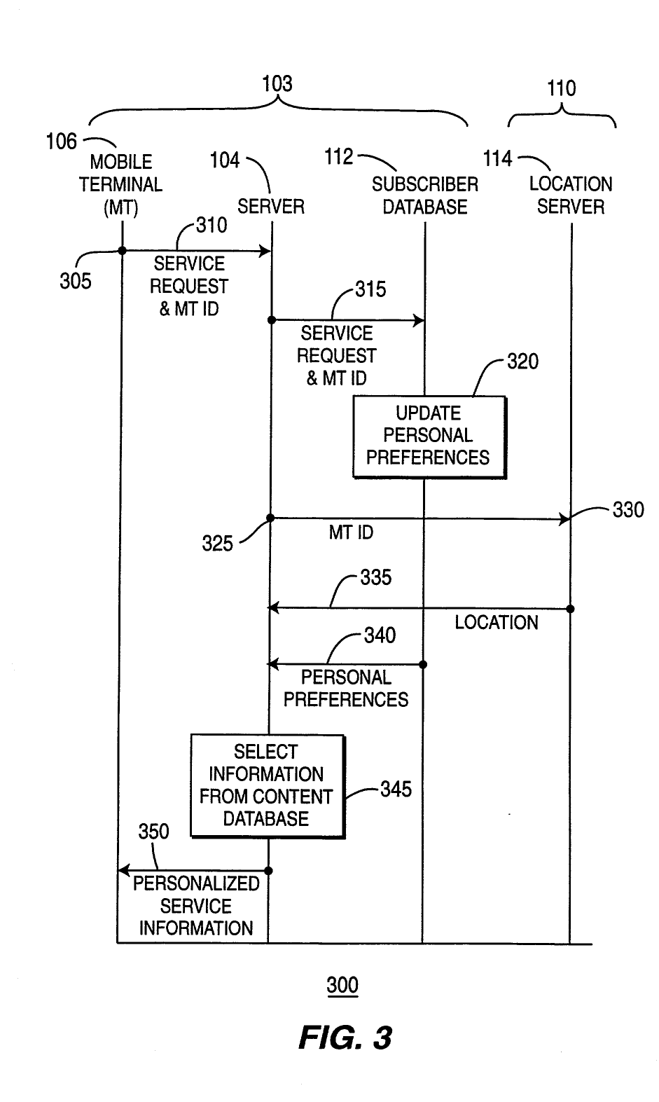

FIG. 3 depicts a data flow chart of a method 300 for providing personalized information to users of mobile terminal devices 106. The data flow chart of FIG. 3 should be viewed in conjunction with FIGS. 1 and 2. The flow chart contains four categories, including the mobile terminal 106, the content server 104, and the subscriber database 112 of the subscriber equipment 103, as well as the location server 114 of the cellular network 110. The flow chart illustratively shows a plurality of communication paths between these four categories (i.e., components) of the wireless communications system 100.

The method 300 begins at step 310, where the mobile terminal 106 sends a service request message and a mobile terminal ID signal to the content server 104 of the service provider 103 through the base station 102 serving a particular geographic location 108 (i.e., cell) that the user is currently located. That is, the user initiates a request for information through the cellular network 110. The user may make a request for general information, or may narrow the request to include or ignore particular user preferences. The base station 102 then relays the mobile terminal communication signal to, for example, the centralized server 104 of the service provider 103, via the cellular network 110. At step 315, the service provider 103 receives a communication signal from the base station 102 and forwards the service request with a mobile terminal ID to the subscriber database 112 for personal profile information.

At step 320, the subscriber database 112 optionally tracks the users request for particular content, and adds the relevant information (i.e., request and selections, if any) to the user's profile. In this manner, the subscriber database 112 automatically updates the user's profile to provide a more reliable search for relevant subject matter for that particular user. It is noted that step 320 may be performed once the request is received by the subscriber database 112, or anytime thereafter.

As discussed above, in one embodiment, the cellular network 110 includes the location server 114 for tracking the location of the mobile terminal 106. In this embodiment, at step 325, the content server 104 forwards the mobile terminal ID signal to the location server 114, to request the current location information of the mobile terminal 106. At step 330, the location server 114 identifies the geographic location (e.g., cell or a particular location within a cell) 108 of the mobile terminal 106 based on the received mobile terminal ID. It is noted that at step 330, the location server 114 stores the current location (i.e., cell 108) of the user. At step 335, the location server 114 sends the location information back to the content server 104.

By knowing the location of the user 302, the content server 104 is able to determine the time zone in which the user is located, and therefore the local time of the user. In other embodiments, the location server may send the local time information with the location information of the mobile terminal. Alternatively, a mobile terminal 106 sends a local time stamp with a service request to the server 104, such that the server 104 may extract the temporal information of the user from the time stamp. Likewise, at step 335, the subscriber database 112 identifies the mobile terminal 106 of the user by the mobile terminal ID, and forwards the selected personal profile back to the content server 104.

At step 345, the content server 104 selects the requested information from the content database 212. In particular, content server 104 identifies the subject matter requested by the user and performs a database search for the requested subject matter (i.e., content) based on the profile (i.e., personalized information) of the user. The search performed by the content server 104 includes a filtering or selection process 214 through the database fields of the content database 212 to retrieve the content that similarly corresponds to the profile of the requesting user.

For example, a user requesting sporting information may have preferences for baseball and golf. Referring to FIG. 1, a server 104 receiving a user request at approximately 6:00 pm for televised sports related subject matter in the first cell 108₁, will first perform a search on a electronic program guide database corresponding to the user's geographic location. The results may be further limited by the time of the request or a time range specifically requested by the user. The server 104 will also narrow the search by searching various titles corresponding to the preferences of the user. In an instance where the user identifies their particular preferences, the server 104 will narrow the search results, accordingly (illustratively, to baseball and golfing events).

The method 300 then proceeds to step 350, where the content server 104 transmits the requested subject matter to the mobile terminal 106 via cellular network 110 and particularly, the base station 102 providing the coverage in the user's geographic location 108. The requested subject matter may then be displayed on the user's mobile terminal 106. Referring to FIG. 1, the requesting user's mobile terminal 106 in the first geographic location 108₁ receives and illustratively displays EPG information relating to local sports (e.g., baseball and golf) events broadcast on television between 6:00 and 6:30 pm. Likewise, a user requesting broadcasted television in the second geographic location 108₂, illustratively, receives EPG movie information corresponding to that users personal profile, time of day, and location (i.e., information based on a combination of spatial, temporal and personal profile data). Similarly, a user requesting movie content in the third geographic location 108₃, illustratively, receives local theatre and movie information (i.e., movie schedule) corresponding to that users personal profile, time of request, and location.

It is important to note that in the embodiment where the mobile terminals have location tracking capabilities of their own (e.g., GPS), then the location server 114 is not required in method 300. Rather, at step 310, the user's location is derived from the mobile terminal 106 and sent directly to the service provider (i.e., content server 104), along with the service request and the mobile terminal ID signal.

Although a single centralized subscriber database 112 is described as storing all the personal profile information of the subscribers, dedicated subscriber databases 112 may be utilized to store particular personal profile information of the subscribers. Moreover, the subscriber database 112 may be distributed and located within other content servers 104 in the communications system 100. For example, in FIG. 1, a content server 104₁ that is dedicated as an EPG server, may contain personal profiles of an EPG for all subscribers, while content server 104ₚ, which is dedicated as a movie/theatre server, has a dedicated subscriber database 112 that stores personal profiles of movies for all subscribers.

Further, although the servers 104 are described as providing information (i.e., content) to a single user (uni-casting), the wireless communications system 100 also contemplates providing information to a group (narrow cast), groups (multicast), or all subscribers/users (broadcast) of the mobile terminals 106. In one embodiment, the service provider 103 may provide advertisement information based on the preferences of the users in a particular geographical location 108. For example, if a major sporting event is occurring in a particular geographical location 108, the service provider 103 may transmit (e.g., multicast) particular advertisements or other information to those users having similar preferences. Local theatre may also wish to entice appropriate subscribers to the available seating at shows.

More sophisticated mobile terminal 106 embodiments (e.g., laptop) may be used as a multi-functional communications device. For example, a user who receives a schedule of local movie theaters may then use the browser of the mobile terminal 106 to hyperlink to a website to purchase movie tickets, and then link to another website to obtain directions to the movie theater.

It is important to note that the present embodiments utilize a combination of spatial, temporal, and personal profile information, as opposed to the prior art services that provide static services, which depend only on spatial (location) parameters, such as for example, finding an ATM machine within a one-mile radius.

Although various embodiments that incorporate the teachings of the present invention have been shown and described in detail herein, those skilled in the art may readily devise many other varied embodiments that still incorporate these teachings. For example, although the step of providing the mobile user is described in the context of a wireless cellular mobile network, it would be apparent to those skilled in the art that the principles of the present invention would equally apply to embodiments of the invention in which transmission of the information is provided through wireless local area networks (WLANs).

What is claimed is:

1. Method for providing information to a mobile terminal associated with a user, comprising:
receiving, from said mobile terminal a request for information;
identifying, in response to the request for information, spatial and temporal information associated with said mobile terminal;
identifying, in response to the request for information, a personal profile associated with said user;
searching for said information, based upon said spatial and temporal information, and personal profile information of the user; and
providing search results to said mobile terminal.

2. The method of claim 1, wherein said searching step further comprises:
acquiring said spatial information associated with said mobile terminal from a location server of a cellular network.

3. The method of claim 1, wherein said searching step further comprises:
acquiring said spatial information from said mobile terminal.

4. The method of claim 1, further comprising updating said personal profile associated with said mobile terminal in response to each information request.

5. The method of claim 4, further comprising the steps of:
monitoring requested content subject matter during each user request for said content;
categorizing said subject matter; and
determining whether said categorized subject matter conforms to a user preference.

6. The method of claim 1, wherein said providing step comprises a transmission selected from the group consisting of unicasting, narrowcasting, multicasting, and broadcasting particular content.

7. The method of claim 1, wherein the searching step further comprises extracting user preferred information.

8. The method of claim 1, wherein said receiving step further comprises:
sending a mobile terminal identification signal to a subscriber database storing said personal profile information; and
sending the mobile terminal identification signal to a location server of a cellular network for locating said mobile terminal.

9. Apparatus for providing information to a mobile terminal, comprising:
a cellular network having a plurality of base stations, each base station providing wireless communication to any mobile terminals within a respective geographic region;
a service provider having a subscriber database storing personal profile information of users of the mobile terminals; and
at least one content server storing content in at least one content database, said content server capable of providing said content based upon location, time, and personal profile of said users.

10. The apparatus of claim 9, wherein said content server is centralized.

11. The apparatus of claim 9, wherein said content server is distributed across said base stations.

12. The apparatus of claim 9, wherein said content server is dedicated to particular subject matter of said content.

13. The apparatus of claim 9, wherein said mobile terminals have capabilities, selected from the group consisting of text messaging, web-browsing, location tracking, multimedia, and remote controlling of multimedia devices.

14. The apparatus of claim 9, wherein said content server provides said content based upon personal preferences of said user.

15. The apparatus of claim 9, further comprising a location server coupled to said cellular network.

16. The apparatus of claim 15, wherein said location server stores spatial information for the mobile terminal upon receiving a mobile terminal identification signal.

17. The apparatus of claim 15, wherein said location server is a gateway mobile location center (GMLC).

18. The apparatus of claim 9, wherein the subscriber database is centralized in the service provider.

19. The apparatus of claim 9, wherein the subscriber database is distributed across said geographic regions.

20. Apparatus for providing information to a mobile terminal, comprising:
means for receiving a request for content:
means for identifying spatial, temporal, and personal profile information corresponding to said request;
means for searching for said content, based upon said spatial, temporal, and personal profile information; and
means for providing search results to said mobile terminal.
